(19) United States
(12) Patent Application Publication
(10) Pub. No.: US 2006/0055083 A1
(43) Pub. Date: Mar. 16, 2006

(54) Method of fabricating nano composite material

(76) Inventors: Doo-Hyun Kim, Seoul (KR); Sang-Kwan Lee, Seoul (KR); Moon-Kwang Um, Seoul (KR); Young-Min Baik, Seoul (KR); In-Soo Kim, Seoul (KR); Seung-Zeon Han, Seoul (KR); Dong-Ho Ha, Seoul (KR)

Correspondence Address: EDELL, SHAPIRO & FINNAN, LLC, 1901 RESEARCH BOULEVARD, SUITE 400, ROCKVILLE, MD, 20850, US

(21) Appl. No.: 10/995,127

(22) Filed: Nov. 24, 2004

(30) Foreign Application Priority Data
Nov. 24, 2003 (KR) 10-2003-0083421
Jul. 2, 2004 (KR) 10-2004-0051668

(51) Int. Cl. B29C 43/02

(52) U.S. Cl. 264/320

(57) ABSTRACT

A method of fabricating a nano composite material includes: forming an intermediate product by loading nano-sized reinforcing materials into an inside of a tube and arranging the nano-sized reinforcing materials in a linear direction; canning the intermediate material by inserting the intermediate material into an inside of a can and sealing the can; evacuating a gas contained in the can; melting the intermediate product in the can by heating the can; preheating a mold; and loading the can into the preheated mold and pressing the mold.

### BACKGROUND OF THE INVENTION

1. Field of the Invention

The present invention relates to a method of fabricating a nano composite material, and more particularly, to a method of fabricating a nano composite material in which a nano-sized reinforcing material can easily be infiltrated even under a low pressure.

2. Description of the Related Art

A composite material is a mixture of at least two chemically distinguishable materials that have bonded together while maintaining their inherent properties. The composite material is artificially created, and mechanical, physical and chemical properties of the respective component materials complement each other such that their properties of component materials are more effective as bonded than when each component materials exist separately.

The component materials generally used for forming a structure of the composite material can be classified into two types: matrix material and reinforcing material. The matrix material bonds together the reinforcing materials, and protects the reinforcing material from an external environment. Also, the matrix material maintains the shape of the composite material, and it has a continuous structure in the composite material. The reinforcing material resists against an external stress thereby allowing the composite material to exhibit better mechanical properties than the matrix material, and it includes particles, whiskers or fabric-type materials dispersed in the matrix material.

The nano composite material refers to a composite material which utilizes a reinforcing material such as carbon nanofiber, carbon nanotube, nano-sized silicon carbide (SiC) or the like, and has advantages through realizing many different functions since it has much better mechanical, thermal and electrical properties than the reinforcing material used in the conventional composite materials.

The nano composite material is generally made using a powder metallurgy and a liquid compression molding. FIG. 1 illustrates a fabrication of a composite material using a liquid compression molding according to the related art.

Referring to FIG. 1, a plurality of reinforcing materials 12 and a liquid copper 14 are loaded in an outer mold 10. An inner molder 16 disposed at an inside of the outer mold 10 moves downward to apply a pressure ‘P’ to the liquid copper 14.

When the pressure is applied to the liquid copper 14 by the inner mold 16, the liquid copper 14 is infiltrated with the reinforcing materials, thereby a composite material is fabricated.

However, in the fabrication of the composite material using the aforementioned liquid compression molding process, the infiltration may be difficult since the liquid copper 14 should be infiltrated into a stack of reinforcing materials.

The liquid copper 14 must reach the reinforcing materials that are placed at the bottom of the stack in order for the infiltration of the liquid copper 14 to occur properly. However, it would require considerable force for the liquid copper 14 to flow in between the stacked reinforcing materials 12. Therefore, in the process of fabricating the composite material using the conventional liquid compression molding, there may be problems since high pressure ‘P’ is required.

### SUMMARY OF THE INVENTION

Accordingly, the present invention is directed to a method of fabricating a nano composite material that substantially obviates one or more problems due to limitations and disadvantages of the related art.

An object of the present invention is to provide a method of fabricating a nano composite material using an intermediate product in which carbon nanofibers or carbon nanotubes in a tube are aligned in series by a drawing.

Another object of the present invention is to provide a method of fabricating a nano composite material that can perform an effective infiltration under low pressure.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of fabricating a nano composite material, the method comprising: a forming step of an intermediate product by loading nano-sized reinforcing materials into a tube and arranging the nano-sized reinforcing materials in a direction; a canning step of inserting the intermediate material into a can and sealing the can; an evacuation step of the can charged with the intermediate product; a melting step of the intermediate product by heating the can; a mold preheating step; and a liquid pressing step of loading the can into the preheated mold and pressing the mold.

The aligning step of the nano-sized reinforcing materials in series may be performed by a plurality of continuous aligning steps.

The aligning step may be a step of drawing the tube into which the nano-sized reinforcing materials are inserted.

The nano-sized reinforcing materials may be a carbon nanofiber or a carbon nanotube.

The tube may be made of copper.

The melting step and the preheating step may be performed at the same time.

The melting step may be performed at a temperature 0.9 to 1.2 times greater than a melting point of the tube material at a maintenance time of 10 to 40 minutes.

The mold in the preheating step may be kept at a temperature that is 0.75 to 1.2 times greater than a melting point of the tube material.

According to the inventive method of fabricating a nano composite material present, an easy fabrication of the nano composite material having superior mechanical strength and electrical property becomes possible.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating a method of fabricating a composite material using a liquid compression molding according to the related art;

FIG. 2 is a process flow diagram illustrating a method of fabricating a nano composite material according to a preferred embodiment of the present invention;

FIG. 3 is a schematic view illustrating a process for forming an intermediate material, which corresponds to a main process of the method of fabricating a nano composite material according to the present invention;

FIG. 4 is partially detailed views of FIG. 3;

FIGS. 5A through 5C are sectional views illustrating inner states of the tube of FIG. 3;

FIG. 6A is a schematic view of a two dimensional preform using an intermediate product fabricated by the process shown in FIG. 3, and FIG. 6B is a schematic view of a three dimensional preform using an intermediate product fabricated by the process shown in FIG. 3;

FIG. 7 is a sectional view illustrating an internal structure of a can where a plurality of intermediate products are loaded;

FIG. 8 is a sectional view illustrating a gas exhaust from an inside of the can shown in FIG. 5;

FIG. 9 is a sectional view of a can illustrating a liquid pressing process according to an embodiment of the present invention;

FIG. 10 is a sectional view of a can illustrating a result from a liquid pressing process;

FIG. 11 is a schematic view illustrating the force balance between the nano-sized reinforcing materials and the melt of tube material due to surface tension during the liquid pressing process according to an embodiment of the present invention;

FIG. 12 is an experimental graph showing a minimal pressure to overcome a surface tension in the liquid pressing process according to an embodiment of the present invention; and

FIG. 13 is an experimental graph illustrating a relationship between a volume fraction of a carbon nanofiber and a compressive force in the liquid pressing process according to an embodiment of the present invention.

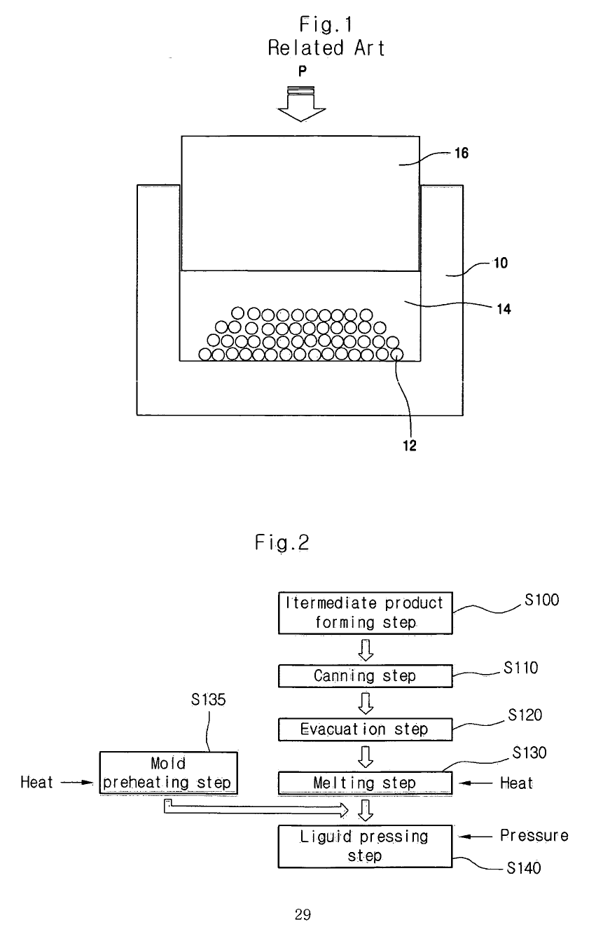

### DETAILED DESCRIPTION OF THE INVENTION

Reference will now be made in detail to the preferred embodiments of the present invention, examples of which are illustrated in the accompanying drawings.

Carbon nanotube (CNT) has a very isotropic structure whose diameter ranges from a few nanometers to a few hundreds nanometers, and a length ranges from a few micrometers to a few hundreds micrometers, and also has a quasi-one dimensional structure where one layer of graphite is wound.

The CNT has conduction properties such as a selective electrical conductivity capable of exhibiting conductor-semiconductor properties depending on a molecular structure, superior thermal conductivity, and a chemical catalyst property using a wide specific surface area. Hence, the CNT provides an opportunity capable of increasing its applications to flat displays which are essential in the information communication apparatus, high integration memory devices, electromagnetic shielding material, electrochemical storage materials such as secondary electric cells, fuel cells or ultra capacitance capacitors, electronic amplifiers, or chemical sensors.

In the meanwhile, carbon nanofiber (CNF) is similar to the CNT. The CNF is obtained at a size ranging from 80 nm to 200 nm by decomposing a gaseous compound containing carbon under a high temperature to generate a carbon material, growing the generated carbon material in the form of fiber on a metallic catalyst fabricated in advance, thermally annealing the intermediate CNF at a temperature of 3,000° C., and refining the thermally annealed CNF. The CNF has a very small diameter compared with the conventional high performance carbon fiber. In other words, the conventional high performance carbon fiber has a diameter ranging from 7 μm to 8 μm, whereas the CNF has a diameter ranging from 80 nm to 200 nm, which is very thin.

Hence, the CNF can increase the tensile strength three times greater than other carbon fibers, and has a thermal conductivity of 1,950 W/m·K or more, which is two times higher than that (1,100 W/m·K) of the pitch-type carbon fiber having the highest thermal conductivity among carbon fibers known up to now. Thus, since the CNF has a high specific surface area, an outstanding electrical conductivity and adsorption, and a better mechanical property, it is used in many applications such as electrode materials, hydrogen storage materials and the like.

As described above, the nano-sized reinforcing materials include CNT, CNF, etc. Hereinafter, a method including forming an intermediate product using the CNF and fabricating a nano composite material by a liquid pressing process using the intermediate product will be described.

FIG. 2 is a process flow diagram illustrating a method of fabricating a nano composite material according to a preferred embodiment of the present invention.

Referring to FIG. 2, an intermediate product forming step (S100) is performed by loading the nano-sized reinforcing materials into an inside of a tube and then the nano-sized reinforcing materials are arranged in a linear direction. Next, a canning step (S110) for liquid compression is performed, and an evacuation step (S120) is performed thereafter. In the evacuation step (S120), the inside of the can where the intermediate product is loaded is made into a vacuum state. Next, a melting step (S130) of the intermediate product, a mold preheating step (S135), and a liquid pressing step (S140) of loading the can into the preheated mold and pressing the mold are sequentially performed.

Hereinafter, the respective steps will now be described in detail.

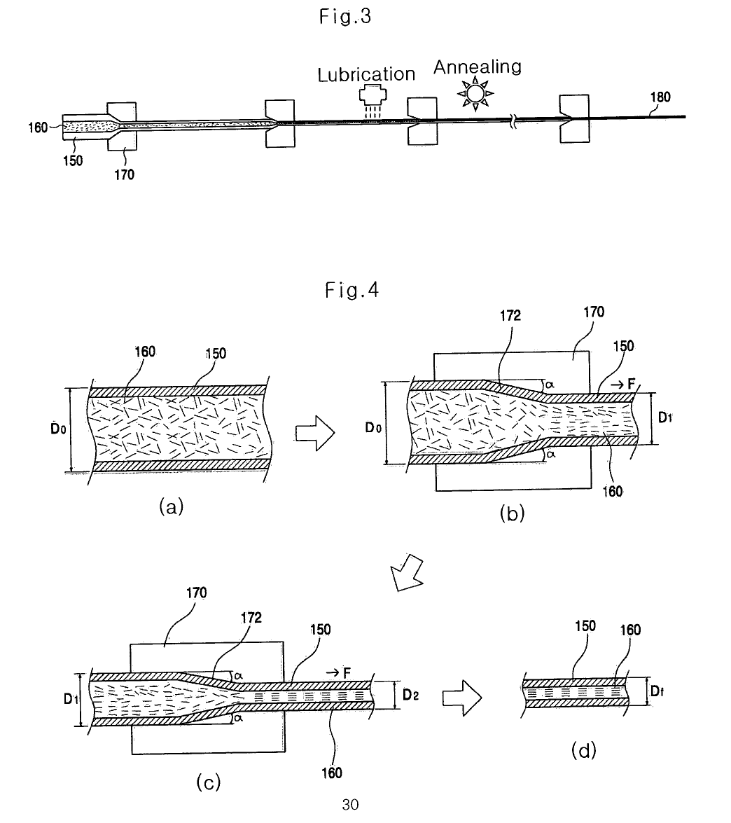

First, the step of forming the intermediate product is described with reference to FIGS. 3 to 6B.

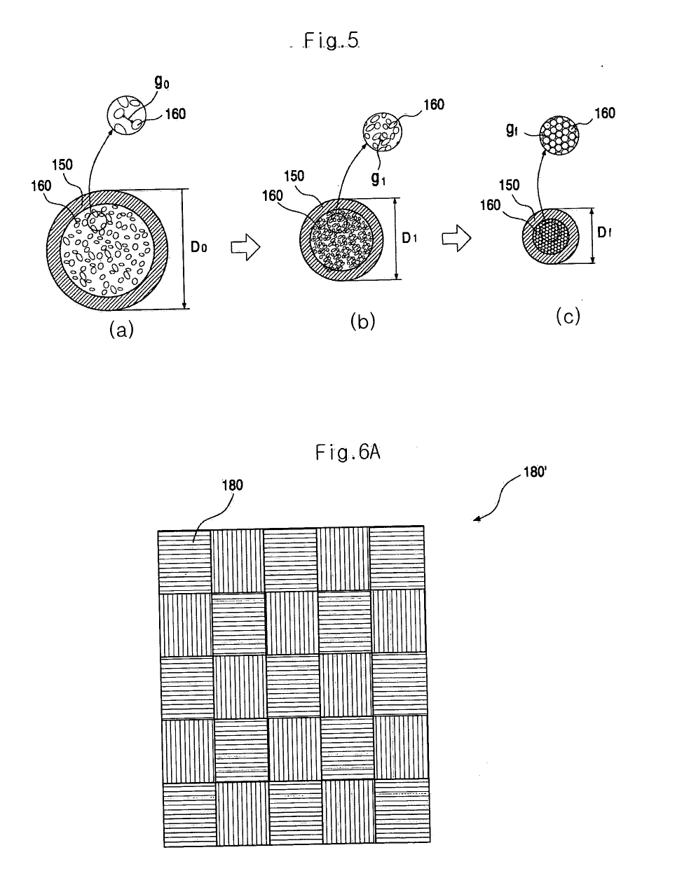

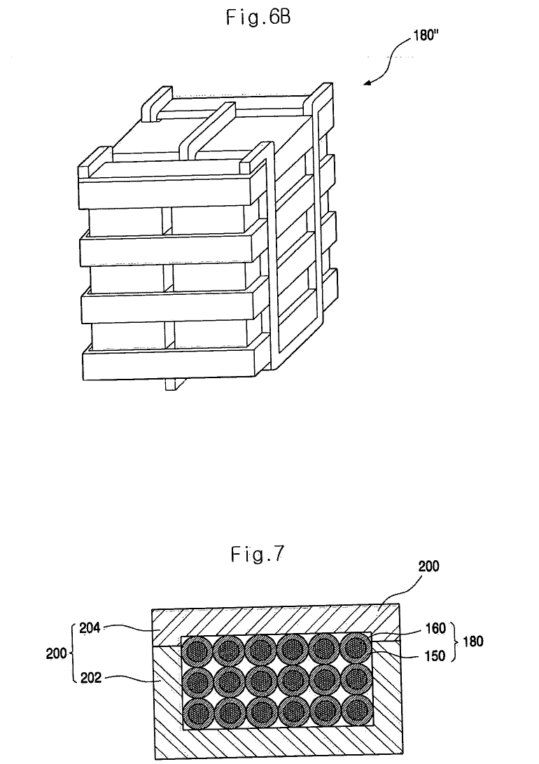

Specifically, FIG. 3 is a schematic view illustrating a process for forming an intermediate material, FIG. 4 is partially detailed views of FIG. 3, and FIGS. 5A through 5C are sectional views illustrating inner states of the intermediate product of FIG. 3, and FIGS. 6A and 6B are exemplary schematic views of two dimensional preform and three dimensional preform using the intermediate product.

Referring to the drawings, a cylindrical tube 150 is provided, and carbon nanofibers (CNFS) 160 are inserted into an inside of the tube 150. The tube 150 is made of a metal material, preferably copper, such that drawing is possible.

The CNFs 160 inserted into the inside of the tube 150 are distributed not in a specific direction but in a random direction as shown in FIG. 4A. The tube 150 having the CNFs 160 therein is subject to multi-stage drawings as shown in FIG. 3.

FIG. 4B shows a drawing of the tube 150 having the CNFs 160 therein. As shown in FIG. 4B, as the tube 150 passes through an inside of a drawing dice 170 during the drawing, the diameter of the tube 150 decreases. Accordingly, the drawing dice 170 is designed such that an inner diameter thereof at an outlet (right of FIG. 4) is formed smaller than that at an inlet (left of FIG. 4). In other words, the inside of the drawing dice 170 has a slope surface 172 inclined by an angle of α. Due to the slope surface 172, the outer diameter of the tube 150 gradually decreases from D₀ to D₁.

For the tube 150 to pass through the drawing dice 170, a drawing force ‘F’ is required. The drawing force ‘F’ decreases as a sectional decrement decreases. In the above embodiment, the sectional decrement is the percentage of a value obtained when a difference between ‘a first sectional area of the tube calculated by the outer diameter D0 of the tube before the drawing’ and ‘a second sectional area of the tube calculated by the outer diameter D1 of the tube after the drawing’ is divided by the first sectional area.

In the meanwhile, it is preferable that the die semi-angle (α) is in the range of 5 degrees to 15 degrees and the sectional decrement is within 15%, which was confirmed by experiments, finite element analysis and theory. As the drawing is progressed, the relative density of the CNF 160 in the tube increases. In other words, as the tube 150 is deformed by the drawing, the CNFs 160 are compressed so that the relative density increases.

Also, the diameter of the tube 150 decreases while the tube 150 passes through the drawing dice 170. At this time, the CNFs 160 in the tube 150 are re-arranged by a shear stress due to deformation of the tube 150 in the portion where the section decreases and friction acting on the inner wall of the tube 150. Accordingly, the CNFs 160 are gradually aligned in the drawing direction after the multi-stage drawings.

In other words, as the drawing advances, the CNFs 160 distributed irregularly are compressed by a plastic deformation of the tube 150 so that the shear stress is generated from the inner wall of the tube 150 due to the friction between the inner wall of the tube 150 and the CNFs 160. The generated shear stress allows the CNFs 160 to be moved from a front end (right side of FIG. 4B) of the tube 150 to a rear end (left side of FIG. 4B), so that the CNFs 160 are arranged in the drawing direction.

Also, residual stress is generated due to the plastic deformation of the tube 150 after the drawing, and the compressive force acting on the CNFs 160 in the inside of the drawing dice 170.

Thus, after passing through the drawing dice 170, the tube has an outer diameter of D1. At this time, the CNFs 160 in the tube 150 are somewhat aligned (1^{st} alignment step).

However, since it is difficult to align the CNFs 160 to a desired degree once, a second drawing is performed as shown in FIG. 4C (2^{nd} alignment step).

In other words, after the 1st alignment step, the outer diameter of the tube 150 becomes D1, and after the 2nd alignment step, the outer diameter of the tube 150 becomes D2.

By doing so, the CNFs 160 with the outer diameter of the tube is D2 are much more aligned than the CNFs 160 with the outer diameter of the tube is D1. Thus, through multi-stage drawings, an intermediate product containing therein the CNFs aligned in one direction is fabricated. FIGS. 4D and 5C show inner sections of the tube that was subject to the multi-stage drawings. As shown in FIGS. 4D and 5C, since the CNFs 160 are closely aligned, a clearance g_{f} between the CNFs 160 is minimized. In other words, a relatively large clearance gₒ of the initial stage shown in FIG. 5A decreases to g1 and then becomes a small clearance g_{f} in the final stage.

When the drawings are completed and the CNFs 160 inside the tube 150 are aligned in one direction, an intermediate product 180 is finally fabricated.

The intermediate products 180 fabricated by the above method are made in the form of a variety of preforms 180′, 180″ by a two-dimensional or three-dimensional weaving for their applications. In other words, the intermediate products 180 are alternatively arranged in a front and rear direction or a left and right direction similarly with the weaving using a general fabric to fabricate a two-dimensional preform 180′ as shown in FIG. 6A.

Besides the aforementioned two-dimensional preform 180′, it is also possible to fabricate a three-dimensional preform 180″ as shown in FIG. 6B. In other words, the intermediate products 180 are three-dimensionally arranged to cross in various directions to fabricate the three-dimensional preform 180″.

Next, a method of forming a nano composite material by a liquid compression of the fabricated intermediate 180 or the perform 180′, 180″.

FIG. 7 illustrates a canning step in which the intermediate products 180 are loaded into a can and sealed. As shown in FIG. 7, a plurality of intermediate products 180 are first loaded into an inside of a can 200. The plurality of intermediate products 180 are stacked in parallel inside the can 200 having a rectangular box shape, and an upper surface of the can 200 is shielded and sealed by a can cover 204 (canning step). At this time, the intermediate products 180 may be in the form of a woven preform 180′, 180″.

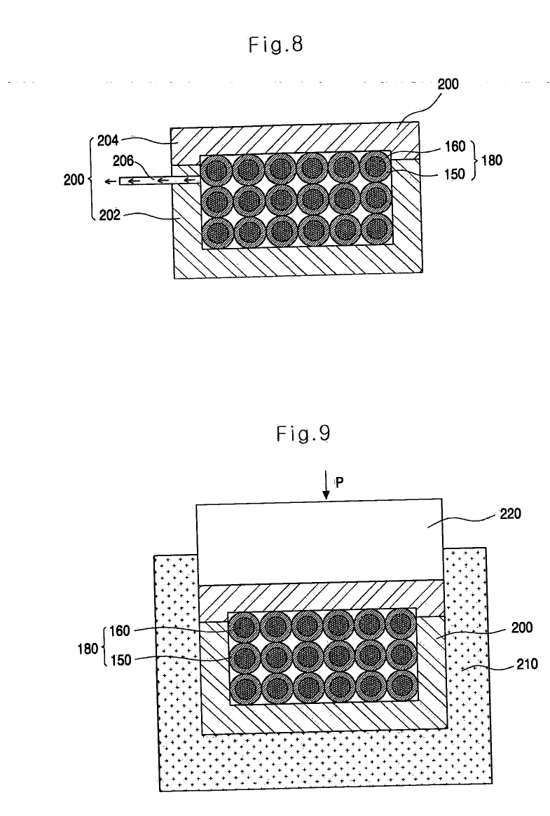

Next, as shown in FIG. 8, the gas inside the can 200 is removed through an exhaust tube 206 constructed to penetrate the can 200. By doing so, the inside of the can is made into a vacuum state. After the gas is exhausted, the exhaust tube 206 is closed (evacuation step). The removal of the gas existing in the can is to prevent a chemical change such as an oxidation caused by the surrounding gas while the tube 150 are being melted.

After the gas in the can 200 is removed, the can is then heated. At this time, it is required to heat the can up to a melting point of the tube 150 such that the tube 150 as a base material is converted into a liquid phase (melting step) while the can 200 is not melted.

In the fabrication method of a nano composite material according to the present invention, it is required that the tube made of copper (Cu) be completely melted while the can 200 made of steel is to be remained in a solid state.

In the melting step, the melting temperature is obtained by the following equation:

Melting temperature T=(0.9 to 1.2)Tm, where Tm is a melting point of the tube material. Maintenance time at the melting temperature is about 10 minutes to 40 minutes.

For example, in case where the tube is made of copper, it is preferable that the can 200 is heated at a temperature of about 1,150° C. for 20 minutes.

In the meanwhile, along with the melting step of the intermediate product 180 by heating the can 200, a preheating step of the mold 210 for pressing the can 200 is performed. Preheating of the mold is necessary to keep the temperature of the melted tube before liquid pressing step.

In the preheating step, it is necessary to keep the temperature Tₒ of the mold 210 above 0.75Tm. More preferably, the temperature Tₒ is (0.75 to 1.2)Tm, where Tm is a melting point of the tube material).

In practice, when the molding is performed at the state in which the can 200 is inserted onto the mold 210 of room temperature, the molding specimen is not sufficiently filled in the mold 210 after liquid pressing step. Unlike the above example, when the molding is performed at the state where the mold 210 is preheated at 800° C., the molding specimen is completely filled in the mold 210 after liquid pressing step. Accordingly, the present invention employs the preheating step of the mold 210 at about 800° C.

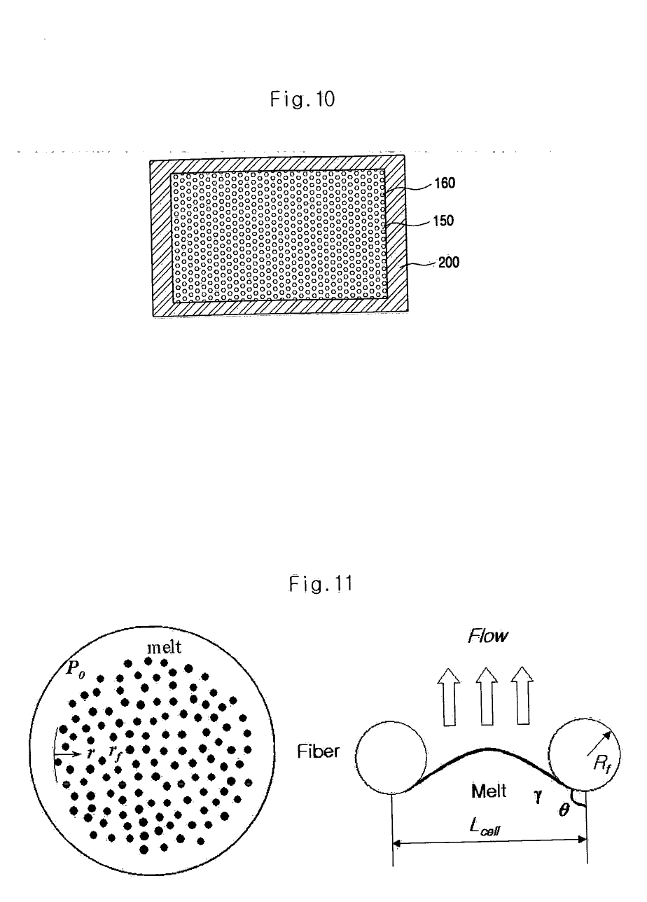

After the can 200 is heated and the mold 210 is preheated, the can 200 is mounted in the mold 210 and a press 220 presses the can 200 at load of ‘P’. By doing so, the can is subject to a hydrostatic pressure, so that the tube 150 of liquid phase is infiltrated between the CNFs 160 as shown in FIG. 10 (liquid pressing step).

In order for the liquid tube 150 to be infiltrated between the CNFs 160, it is necessary to overcome the surface. In other words, in order for the copper (Cu) melt to be infiltrated between CNFs 160, it is required that the Cu melt flows between the CNFs 160. To this end, it is necessary to overcome the surface tension.

The surface tension hinders the Cu melt from being infiltrated between the CNFs 160. A force for overcoming the surface tension can be calculated from a force equilibrium equation.

For example, as shown in FIG. 11, when the flow of the Cu melt is limited due to the surface tension acting on two-stranded fabrics, a relationship between such parameters can be expressed in the following means:
3γcos θ=L_{cell}·ΔP,

$$Δ P = \frac{3 γ cos θ}{{L}_{cell}} ,$$

where ΔP is a pressure value considerable to the surface tension, a surface tension of the Cu melt, γ is 2.4 N/m, and a contact angle θ is 120°.

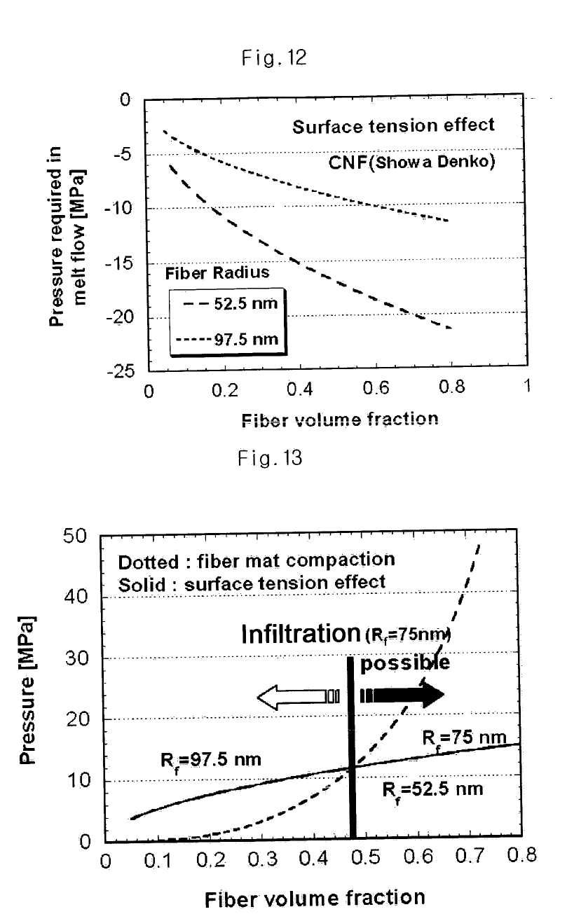

Resultant pressure values of the above equation are shown in FIG. 12. In the graph shown in FIG. 12, the negative pressure value means that the surface tension hinders the flow.

In the meanwhile, when the pressure ‘P’ acting on the press 220 increases gradually, in an initial stage, the surface tension hinders the flow so that the tube 150, i.e., the Cu melt is not infiltrated between the CNFs 160 but is used to compress the CNFs 160.

Thereafter, the infiltration starts as the pressure P1 becomes greater than the surface tension. Once the flow of the Cu melt starts, the Cu melt is completely filled between the CNFs 160 within a very short period of time (1 to 2 seconds).

Experimental values in FIG. 13 show that the infiltration starts when a radius of the CNF 160 is 75 nm and the pressure P1 is above 11.7 MPa. Volume fraction of the CNFs is controllable in the drawing operation for forming the intermediate products 180. In general, as the volume fraction of the CNFs increases, the strength of the composite material increases.

To start the infiltration, an additive pressure P2 for the plastic deformation of the can 200 is further required in addition to the pressure required to overcome the surface tension. In other words, when the can 200 is plastically deformed and crumpled by the pressure ‘P’ applied to the press 220, a pressure is applied to the Cu melt, so that the infiltration starts due to the hydrostatic pressure.

Accordingly, the applied pressure ‘P’ is a sum of the theoretical minimum pressure ‘P1’ necessary for the infiltration of the Cu melt, and the pressure ‘P2’ necessary for the plastic deformation of the can 200. For example, when P1 is 11.7 MPa and P2 is 25.0 MPa, the applied pressure ‘P’ should be at least above 36.7 MPa.

As described above, according to the present invention, the CNFs in the tube are aligned by multi-stage drawings to fabricate intermediate products. From the intermediate products themselves or a variety of preforms using the intermediate products, a nano composite material is fabricated by a liquid pressing process.

Accordingly, it is possible to fabricate the nano composite material using a low pressure. In other words, compared with the conventional method that a matrix material such as copper is infiltrated in a state that the plurality of CNFs are stacked, the method according to the present invention using the intermediate products can shorten the infiltration distance, so that it is easy to infiltrate the matrix material between the CNFs, thereby enhancing the production efficiency of the nano composite material.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of fabricating a nano composite material, the method comprising:
forming an intermediate product by loading nano-sized reinforcing materials into an inside of a tube and arranging the nano-sized reinforcing materials in a linear direction;
canning the intermediate material by inserting the intermediate material into an inside of a can and sealing the can;
evacuating a gas contained in the can where the intermediate product is inserted;
melting the intermediate product in the can by heating the can;
preheating a mold; and
loading the can into the preheated mold and pressing the mold.

2. The method according to claim 1, wherein arranging the nano-sized reinforcing materials includes aligning the nano-sized reinforcing materials in series via a plurality of continuous aligning steps.

3. The method according to claim 2, wherein aligning the nano-sized reinforcing materials includes drawing the tube into which the nano-sized reinforcing materials are inserted.

4. The method according to claim 1, wherein the nano-sized reinforcing materials are a carbon nanofiber or a carbon nanotube.

5. The method according to claim 1, wherein the tube is made of copper.

6. The method according to claim 1, wherein the melting and the preheating are performed at the same time.

7. The method according to claim 1, wherein the melting is performed at a melting temperature which is 0.9 to 1.2 times greater than a melting point of the tube material at a maintenance time of 10 to 40 minutes.

8. The method according to claim 6, wherein the melting is performed at a temperature which is 0.9 to 1.2 times greater than a melting point of the tube material at a maintenance time of 10 to 40 minutes.

9. The method according to claim 1, wherein the mold that is preheated is kept at a temperature 0.75 to 1.2 times greater than a melting point of the tube material.

10. The method according to claim 6, wherein the mold that is preheated is kept at a temperature 0.75 to 1.2 times greater than a melting point of the tube material.
